(19) United States
(12) Patent Application Publication
(10) Pub. No.: US 2025/0317910 A1
(43) Pub. Date: Oct. 9, 2025

(54) SLOT COUNTING AND UPLINK REPETITION CONSIDERATIONS UNDER DYNAMIC SYNCHRONIZATION SIGNAL BLOCK ADAPTATION

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Diana MAAMARI, San Diego, CA (US)

(21) Appl. No.: 18/630,889

(22) Filed: Apr. 9, 2024

(51) Int. Cl. H04W 72/0446; H04L 1/08

(52) U.S. Cl. CPC H04W 72/0446; H04L 1/08

(57) ABSTRACT

Methods, systems, and devices for wireless communications are described. A user equipment (UE) may receive first control signaling indicating a first set of slots allocated for one or more synchronization signal blocks (SSBs). A first set of candidate uplink slots for uplink repetition may be based on the first set of slots. The UE may receive second control signaling that indicates an update to the first set of slots allocated for the one or more SSBs resulting in a second set of slots allocated for the one or more SSBs. A second set of candidate uplink slots for uplink repetition may be based on the second set of slots. The UE may perform an uplink repetition counting procedure based on the second set of candidate uplink slots for uplink repetition.

### FIELD OF TECHNOLOGY

The following relates to wireless communications, including slot counting and uplink repetition considerations under dynamic synchronization signal block (SSB) adaptation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support slot counting and uplink repetition considerations under dynamic synchronization signal block (SSB) adaptation. For example, the described techniques provide for receiving, at a user equipment (UE), first control signaling indicating a first set of slots allocated for one or more SSBs. A first set of candidate uplink slots for uplink repetition may be based on the first set of slots. The UE may receive second control signaling that indicates an update to the first set of slots allocated for the one or more SSBs resulting in a second set of slots allocated for the one or more SSBs. A second set of candidate uplink slots for uplink repetition may be based on the second set of slots. The UE may perform an uplink repetition counting procedure based on the second set of candidate uplink slots for uplink repetition.

A method for wireless communications by a UE is described. The method may include receiving first control signaling indicating a first set of slots allocated for one or more SSBs, where a first set of multiple candidate uplink slots for uplink repetition are based on the first set of slots, receiving second control signaling that indicates an update to the first set of slots allocated for the one or more SSBs resulting in a second set of slots allocated for the one or more SSBs, where a second set of multiple candidate uplink slots for uplink repetition are based on the second set of slots, and performing an uplink repetition counting procedure based on the second set of multiple candidate uplink slots for uplink repetition.

A UE for wireless communications is described. The UE may include one or more memories storing processor executable code, and one or more processors coupled with the one or more memories. The one or more processors may individually or collectively be operable to execute the code to cause the UE to receive first control signaling indicating a first set of slots allocated for one or more SSBs, where a first set of multiple candidate uplink slots for uplink repetition are based on the first set of slots, receive second control signaling that indicates an update to the first set of slots allocated for the one or more SSBs resulting in a second set of slots allocated for the one or more SSBs, where a second set of multiple candidate uplink slots for uplink repetition are based on the second set of slots, and perform an uplink repetition counting procedure based on the second set of multiple candidate uplink slots for uplink repetition.

Another UE for wireless communications is described. The UE may include means for receiving first control signaling indicating a first set of slots allocated for one or more SSBs, where a first set of multiple candidate uplink slots for uplink repetition are based on the first set of slots, means for receiving second control signaling that indicates an update to the first set of slots allocated for the one or more SSBs resulting in a second set of slots allocated for the one or more SSBs, where a second set of multiple candidate uplink slots for uplink repetition are based on the second set of slots, and means for performing an uplink repetition counting procedure based on the second set of multiple candidate uplink slots for uplink repetition.

A non-transitory computer-readable medium storing code for wireless communications is described. The code may include instructions executable by one or more processors to receive first control signaling indicating a first set of slots allocated for one or more SSBs, where a first set of multiple candidate uplink slots for uplink repetition are based on the first set of slots, receive second control signaling that indicates an update to the first set of slots allocated for the one or more SSBs resulting in a second set of slots allocated for the one or more SSBs, where a second set of multiple candidate uplink slots for uplink repetition are based on the second set of slots, and perform an uplink repetition counting procedure based on the second set of multiple candidate uplink slots for uplink repetition.

Some examples of the method, UEs, and non-transitory computer-readable medium described herein may further include operations, features, means, or instructions for performing a second uplink repetition counting procedure based on the first set of multiple candidate uplink slots for uplink repetition before receiving the second control signaling, where performing the uplink repetition counting procedure includes updating the uplink repetition counting procedure according to the second set of multiple candidate uplink slots for uplink repetition.

Some examples of the method, UEs, and non-transitory computer-readable medium described herein may further include operations, features, means, or instructions for receiving, via the second control signaling, an indication of at least a slot allocated for SSB that overlaps with a first candidate uplink slot of the first set of multiple candidate uplink slots.

Some examples of the method, UEs, and non-transitory computer-readable medium described herein may further include operations, features, means, or instructions for dropping the first candidate uplink slot from the second set of multiple candidate uplink slots.

In some examples of the method, UEs, and non-transitory computer-readable medium described herein, the uplink repetition counting procedure may include operations, features, means, or instructions for counting a new slot that does not overlap with the first candidate uplink slot towards a total quantity of uplink repetition slots associated with the second set of multiple candidate uplink slots, where the second set of multiple candidate uplink slots includes the new slot.

In some examples of the method, UEs, and non-transitory computer-readable medium described herein, the uplink repetition counting procedure may include operations, features, means, or instructions for refraining from counting the first candidate uplink slot towards a total quantity of uplink repetition slots associated with the second set of multiple candidate uplink slots.

In some examples of the method, UEs, and non-transitory computer-readable medium described herein, the total quantity of uplink repetition slots associated with the second set of multiple candidate uplink slots may be less than a total quantity of uplink repetition slots associated with the first set of multiple candidate uplink slots.

Some examples of the method, UEs, and non-transitory computer-readable medium described herein may further include operations, features, means, or instructions for receiving, via the second control signaling, an indication that at least a slot of the first set of slots allocated for the one or more SSBs may be not included in the second set of slots allocated for the one or more SSBs, such that the slot may be not allocated for the one or more SSBs.

In some examples of the method, UEs, and non-transitory computer-readable medium described herein, the uplink repetition counting procedure may include operations, features, means, or instructions for counting the slot towards a total quantity of uplink repetition slots associated with the second set of multiple candidate uplink slots, where the second set of multiple candidate uplink slots includes the slot.

In some examples of the method, UEs, and non-transitory computer-readable medium described herein, the uplink repetition counting procedure may include operations, features, means, or instructions for refraining from counting a last candidate uplink slot of the first set of multiple candidate uplink slots towards the total quantity of uplink repetition slots associated with the second set of multiple candidate uplink slots based on counting the slot.

In some examples of the method, UEs, and non-transitory computer-readable medium described herein, the uplink repetition counting procedure may include operations, features, means, or instructions for allocating the slot for a repetition of a previous slot of the second set of multiple candidate uplink slots.

Some examples of the method, UEs, and non-transitory computer-readable medium described herein may further include operations, features, means, or instructions for receiving, via the second control signaling, an indication of the uplink repetition counting procedure, where the uplink repetition counting procedure indicates for the UE to skip uplink repetitions on a removed uplink slots.

Some examples of the method, UEs, and non-transitory computer-readable medium described herein may further include operations, features, means, or instructions for receiving, via the second control signaling, an indication of the uplink repetition counting procedure, where the uplink repetition counting procedure indicates for the UE to reschedule uplink repetitions on a removed uplink slots.

Some examples of the method, UEs, and non-transitory computer-readable medium described herein may further include operations, features, means, or instructions for transmitting one or more uplink repetitions via the second set of multiple candidate uplink slots according to the uplink repetition counting procedure.

### BRIEF DESCRIPTION OF THE DRAWINGS

FIG. 1 shows an example of a wireless communications system that supports slot counting and uplink repetition considerations under dynamic synchronization signal block (SSB) adaptation in accordance with one or more aspects of the present disclosure.

FIG. 2 shows an example of a wireless communications system that supports slot counting and uplink repetition considerations under dynamic SSB adaptation in accordance with one or more aspects of the present disclosure.

FIG. 3 shows an example of a counting procedure that supports slot counting and uplink repetition considerations under dynamic SSB adaptation in accordance with one or more aspects of the present disclosure.

FIG. 4 shows an example of a counting procedure that supports slot counting and uplink repetition considerations under dynamic SSB adaptation in accordance with one or more aspects of the present disclosure.

FIG. 5 shows an example of a process flow that supports slot counting and uplink repetition considerations under dynamic SSB adaptation in accordance with one or more aspects of the present disclosure.

FIGS. 6 and 7 show block diagrams of devices that support slot counting and uplink repetition considerations under dynamic SSB adaptation in accordance with one or more aspects of the present disclosure.

FIG. 8 shows a block diagram of a communications manager that supports slot counting and uplink repetition considerations under dynamic SSB adaptation in accordance with one or more aspects of the present disclosure.

FIG. 9 shows a diagram of a system including a device that supports slot counting and uplink repetition considerations under dynamic SSB adaptation in accordance with one or more aspects of the present disclosure.

FIGS. 10 through 12 show flowcharts illustrating methods that support slot counting and uplink repetition considerations under dynamic SSB adaptation in accordance with one or more aspects of the present disclosure.

### DETAILED DESCRIPTION

In some wireless communications systems, a user equipment (UE) may be scheduled to transmit one or more repetitions of an uplink message via available slots (e.g., slots allocated for uplink transmissions, slots allocated as flexible for uplink transmissions, or both). The UE may identify a quantity of available slots for the repetitions of the uplink transmission based on an uplink repetition counting procedure. The uplink repetition counting procedure may be based on a first set of slots schedule for downlink transmissions (e.g., synchronization signal block (SSB) transmissions) that are not available for uplink transmissions (e.g., SSBs scheduled in flexible slots, rending those slots unavailable for uplink transmissions). The uplink repetition counting procedure may identify available slots for uplink transmission (e.g., candidate slots), and the counting procedure may associate available slots with a repetition of an uplink transmission (e.g., a first available slot for a first repetition, a second available slot for a second repetition, etc.).

In some cases, a network entity may dynamically update the first set of slots scheduled for downlink transmissions (e.g., may dynamically update SSB scheduling, periodicity, etc.). The dynamic update may allocate a slot for downlink transmission (e.g., may schedule an SSB in a previously available slot) or may deallocate a slot for downlink transmission (e.g., may remove a previously scheduled SSB from a slot, rending the slot newly available for uplink repetitions). In some cases, the dynamic update may allocate a first slot for an SSB transmission. If the first slot was previously counted as an available slot, the dynamically scheduled SSB transmission may overlap with a counted repetition of the uplink transmission. The overlapping transmission may cause interference. In some cases, the dynamic update may indicate a deallocation of a second slot previously allocated for an SSB transmission. The cancelation of the SSB may make the second slot available for uplink transmission. If the UE does not count the second slot in the uplink counting procedure, the UE may inefficiently fail to utilizes available system resources. Such interference and inefficiency may result in inefficient use of available system resources, decreased reliability of wireless signaling, increased system latency, and decreased user experience.

According to techniques described herein, the network entity may transmit control signaling (e.g., a dynamic adaptation received via control signaling) including an indication of an update to the first set of slots for downlink transmission (e.g., a dynamic update for SSB signaling). In some examples, the network entity may transmit an indication that a first previously available slot has been allocated for an SSB transmission. In some examples, the network entity may transmit an indication that a second slot previously allocated for an SSB transmission has been deallocated and may now be available for uplink transmission. The UE may identify updated available slots for uplink repetition based on the first set of slots and the dynamic adaptation. The UE may perform an uplink repetition counting procedure based on the updated available slots. The dynamic adaptation and the uplink repetition counting procedure may improve coordination between device and increase efficient utilization of communication resources.

Aspects of the disclosure are initially described in the context of wireless communications systems. Additional aspects of the disclosure may be described in the context of counting procedures and a process flow. Aspects of the disclosure are further illustrated by and described with reference to apparatus diagrams, system diagrams, and flowcharts that relate to slot counting and uplink repetition considerations under dynamic SSB adaptation.

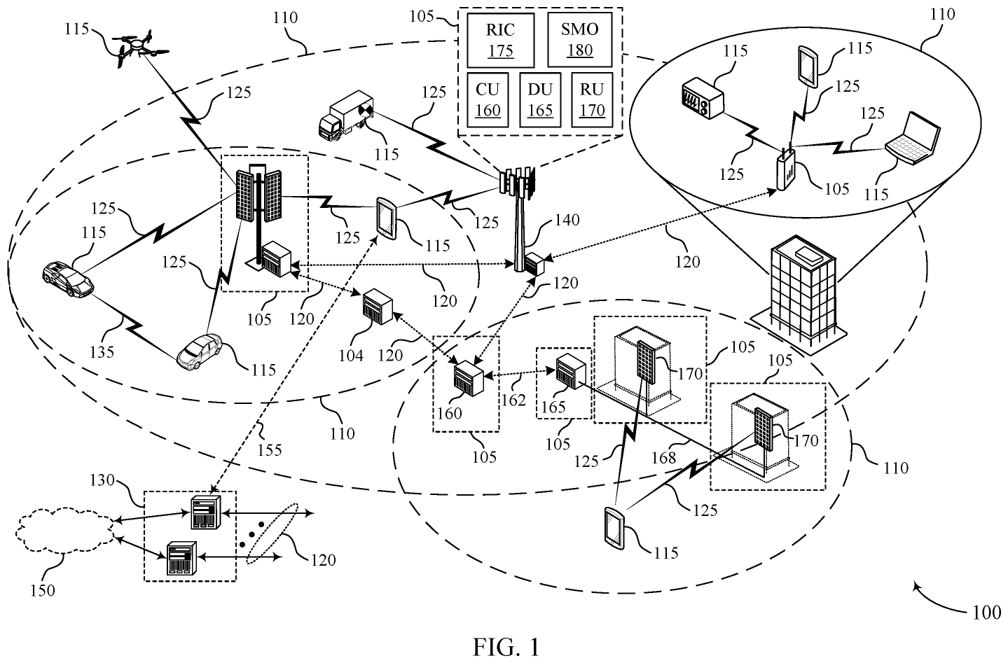

FIG. 1 shows an example of a wireless communications system 100 that supports slot counting and uplink repetition considerations under dynamic SSB adaptation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, a UE 115 may perform an uplink repetition counting procedure (e.g., physical uplink shared channel (PUSCH) repetitions for PUSCH Rep Type A). The uplink repetition counting procedure may be based on physical slots. In some cases, the uplink repetition counting procedure may count downlink slots. For example, the UE 115-a may increment a repetition counter without transmitting an uplink repetition on downlink slots. In some cases, the quantity of actual repetitions may be lower than the desired quantity of repetitions (e.g., in TDD bands). In some cases, the uplink repetition counting procedure may be based on a set of available slots (e.g., based on existing design for physical uplink control channel (PUCCH) repetitions).

The UE 115 may select up to 32 PUSCH repetitions for dynamic grant PUSCH (DG-PUSCH) and configured grant PUSCH (CG-PUSCH). For example, an RRC parameter (e.g., RepK parameter) range (e.g., in ConfiguredGrantConfig) may be increased to enable Type 1 CG-PUSCH to be configured with up to 32 repetitions. For example, a UE 115 may be configured with a “downlink downlink downlink shared uplink” slot pattern, The UE 115 may determine seven actual repetitions are possible based on the slot pattern. Additionally, or alternatively, non-terrestrial network (NTN) systems may benefit from the increase in the maximum quantity of repetitions (e.g., when connecting to a UE 115).

According to techniques described herein, the network entity 105 may transmit control signaling including an indication of an update to the first set of slots for downlink transmission. In some examples, the network entity 105 may transmit an indication that a first previously available slot has been allocated for an SSB transmission. In some examples, the network entity may transmit an indication that a second slot previously allocated for an SSB transmission has been deallocated and may now be available for uplink transmission. The UE 115 may identify updated available slots for uplink repetition based on the first set of slots and the control signaling indicating the dynamic adaptation. The UE 115 may perform an uplink repetition counting procedure based on the updated available slots. The control signaling indicating the dynamic adaptation and the uplink repetition counting procedure may improve coordination between device and increase efficient utilization of communication resources.

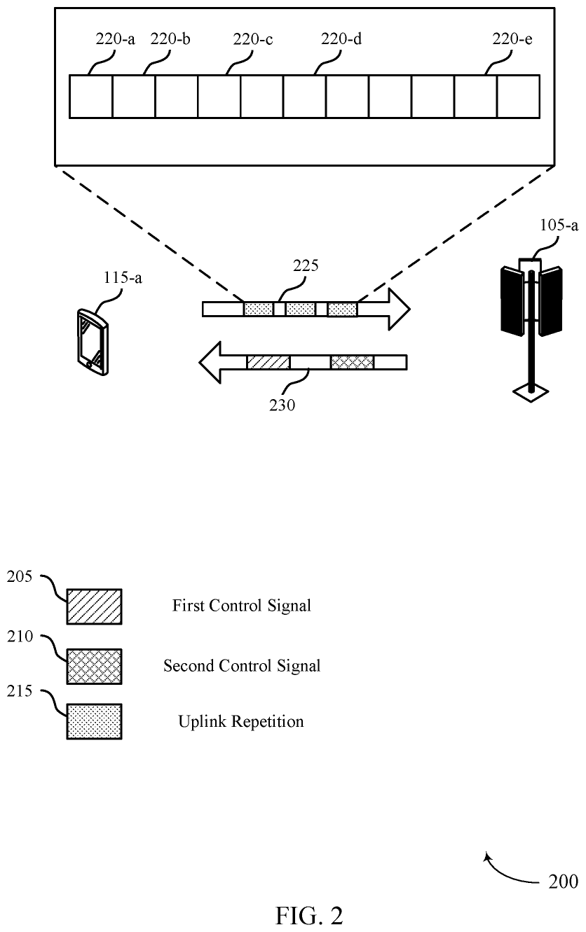

FIG. 2 shows an example of a wireless communications system 200 that supports slot counting and uplink repetition considerations under dynamic SSB adaptation in accordance with one or more aspects of the present disclosure. In some examples, wireless communications system 200 may implement aspects of wireless communications system 100. For example, a UE 115-a may represent an example of a UE, such as the UEs 115 described herein with reference to FIG. 1. The network entity 105-a may represent an example of a network entity, such as the network entity 105 described herein with reference to FIG. 1. The UE 115-a and the network entity 105-a may communicate via an uplink communications link 225 a downlink communications link 230, or both. As described herein, the network entity 105-a may transmit a first control signal 205 (e.g., RRC signaling) scheduling SSB transmissions. The network entity 105-a may transmit a second control signal 210 including an update to SSB scheduling (e.g., a dynamic adaptation of the previously scheduled SSBs). The UE 115-a may allocated slots 220 for uplink repetitions 215 and transmit the uplink repetitions 215 based on the SSB scheduling.

In some wireless communications systems, the UE 115-a may perform a first uplink repetition counting procedure (e.g., slot counting for uplink repetition) based on the first periodicity prior to receiving the second control signal 210. For example, the first uplink repetition counting procedure and mapping of uplink repetitions to counted slots may be determined prior to the receiving the second control signal 210. Additionally, or alternatively, the first uplink repetition counting procedure may depend on the available RRC configuration (e.g., the first control signal 205). The first uplink repetition counting procedure may be determined by slot availability. If an SSB is scheduled in a flexible slot 220, then the slot 220 may not be counted for uplink repetition. If an SSB is not scheduled in a flexible slot 220, the flexible slot 220 may be counted for uplink repetitions. For example, the UE 115-a may determine the set of available slots 220 (e.g., a set of candidate slots 220) based on the slots 220 not being scheduled for SSB or other downlink transmission (e.g., the set of candidate slots 220 may include uplink slots, flexible slots that are not otherwise allocated or utilized for downlink signaling, or any combination thereof). The UE 115-a may select a set of slots 220 associated with a repetition factor from a set of available slots 220 (e.g., multiple candidate uplink slots 220 for uplink repetition). The UE 115-a may select the set of candidate slots 220 in accordance with a repetition factor. The set of candidate slots 220 may be associated with a time period spanning the set of candidate slots 220. The UE 115-a may expect that the available slots 220 will not change during the time period (e.g., the first control signal may be RRC signaling indicating a relatively static configuration for downlink signaling such as SSBs over the time period or until otherwise configured).

For example, the UE 115-a may determine K available slots 220 (e.g., candidate slots 220) for K repetitions, where a slot 220 is available if all the symbols contained in the time domain resource allocations (TDRA) are either uplink or flexible symbols (e.g., as indicated by RRC signaling, such as a tdd-UL-DL-ConfigurationCommon indication, or tdd-UL-DL-ConfigurationDedicated indication) and are not used for SSB transmission (e.g., as indicated by SSBPositionsInBurst in system information block one (SIB1)). The UE 115-a may determine K available slots 220 based on the slot 220 having no dependency on SFI and based on SSB transmission (e.g., as per SSBPositionInBurst in SIB1). Additionally, or alternatively, if the second control signal is received before the UE 115-a determines K available slots 220, the UE 115-a may determine the K available slots 220 based on the SIB1 indication and not the dynamic indication. If the dynamic indication adaptation is received after the repetition determination, then the repetition determination may be impacted due to a collision the uplink repetition and an SSB transmission. In some cases, the network entity 105-a may indicate that dynamic slot form indication (SFI) is supported or not supported. That is, SFI may be an optional feature, or may not be available to or supported by some or all devices in the wireless communications system 200.

In some cases, the UE 115-a may perform the first uplink repetition counting procedure based on an RRC configuration (e.g., TDD_configcommon and TDD_configdedicated). The uplink repetition counting may be determined based on the RRC configuration. The UE 115-a may allocate slots 220 based on the uplink repetition counting procedure for future time periods. That is, the UE 115-a may expect that the available slots 220 may not change based on the RRC configuration. However, if dynamic adaptation of the SSBs occur, techniques described herein may avoid collisions or inefficient use of available system resources.

When the UE 115-a receives the second control signal 210, which may change the availability of one or more slots 220, a second counting procedure may occur. The second counting procedure may impact uplink repetitions (e.g., which may have already been previously determined according to the first counting procedure). The UE 115-a may determine whether to drop a PUSCH repetition or not based on one or more conditions or dropping rules, as described herein. The PUSCH repetition may still counted in the K repetitions. For example, the UE 115-a may count an uplink repetition 215 even if the uplink repetition 215 is dropped (e.g., not transmitted).

The UE 115-a may perform the first uplink counting procedure (e.g., determine K slots 220) based on semi-static configurations. The UE 115-a may drop PUSCH repetitions based on dynamic events (e.g., dynamic SFI or grants for higher priority channels). The semi-static configuration for the first uplink counting procedure and dynamic events for dropping ensure robustness to the UE 115-a missing downlink control information (DCI) transmission (e.g., even if the UE 115-a misses a DCI transmission, the UE 115-a and network entity 105-a may remain in sync on available slots 220).

In some cases, the network entity 105-a may transmit a first control signal 205 including an indication of SSB scheduling. The network entity 105-a may transmit a second control signal 210. The second control signal 210 may indicate an adaptation of SSB in the time domain (e.g., an adaptation of a periodicity or burst position associated with the SSB). For example, the second control signal 210 may update the periodicity associated with an SSB from a first periodicity (e.g., 20 ms) to a second periodicity (e.g., 40 ms). The second control signal 210 may allocate more slots 220 for SSB transmission, or the second control signal 210 may deallocate slots 220 for SSB transmission (e.g., by changing locations of an SSB, or by increasing a periodicity, among other examples). When the UE 115-a receives a second control signal (e.g., a dynamic adaptation of SSB), the updated SSB transmissions may change the counting (e.g., the first uplink repetition counting procedure) or the availability of the slots 220. The updated availability of slots 220 may impact uplink repetitions that was already decided (e.g., scheduled during the first uplink repetition counting procedure).

The second control signal 210 may affect scheduling decisions at the UE 115-a. During the time period spanning the set of candidate slots 220 for uplink repetition, the UE 115-a may receive the second control signal 210. In some cases, the second control signal 210 may alter the set of available slots 220 based on an update to the SSB scheduling. In some examples, the network entity 105-a transmit a second control signal 210 including an indication of an update to SSB scheduling such that previously available slots 220 in the set of available slots 220 may no longer be available based on the previously available slots 220 being scheduled for SSB transmission. For example, an SSB transmission may overlap with an available slot 220 in the set of candidate slots 220. In some examples, the network entity 105-a may transmit a second control signal 210 including an indication of an update to SSB scheduling such that previously unavailable slots 220 scheduled for SSB transmission may be available based on the previously unavailable slots 220 no longer being allocated for SSB transmissions.

The UE 115-a may perform the first uplink counting procedure prior to or during a slot 220-a. The UE 115-a may identify available slots 220 (e.g., slot 220-b, slot 220-d, and slot 220-e) for uplink repetitions 215 in accordance with an uplink repetition factor of three and based on the first control signal 205. The UE 115-a may receive a second control signal 210. In some cases, the second control signal 210 may update the SSB scheduling such that an SSB transmission may be scheduled during the slot 220-d (e.g., an available slot 220 selected for an uplink repetition 215). In some cases, the second control signal 210 may update the SSB scheduling such that a slot 220-c scheduled for an SSB transmission may become available. For example, the slot 220-c may not be allocated for an SSB transmission after the second control signal 210. If the UE 115-a does not update the set of candidate slots 220 based on the second control signal 210, the UE 115-a may transmit an uplink repetition to the network entity 105-a while the network entity 105-a transmits an SSB. Additionally, or alternatively, the UE 115-a may not utilize a previously unavailable slot 220, which may decrease efficient use of communication resources.

According to techniques described herein, the UE 115-a may perform an uplink repetition counting procedure based on the second control signal 210. In some cases, the UE 115-a may receive a second control signal 210 (e.g., indicating a dynamic adaptation of SSB in the time domain) after the UE 115-a has already determined the available uplink slots 220 for uplink repetition (e.g., performed the first uplink repetition counting procedure).

In some cases, the UE 115-a may drop the entire transmission (e.g., the remaining uplink repetitions) regardless of the dynamic SSB adaptation. That is, the UE 115-a may stop the uplink transmission based on the dynamic SSB adaptation due to potential dropping or change in quantity of repetitions which may not be decoded correctly by the network entity 105-a. The UE 115-a may refrain from transmitting all (e.g., or any remaining un-transmitted) uplink repetitions 215 based on receiving the second control signal 210.

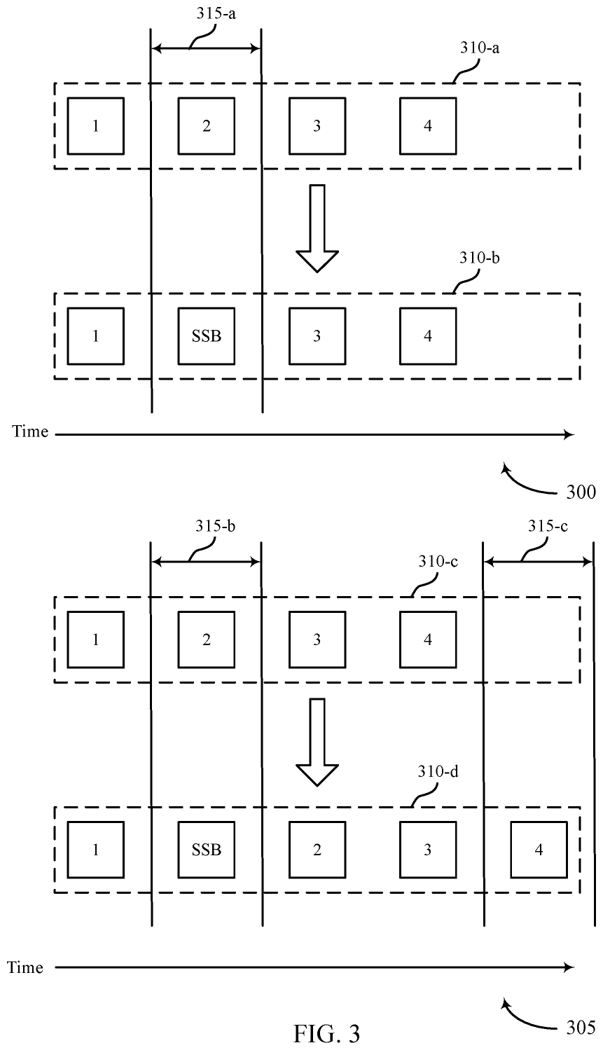

In some cases, the second control signal 210 may add a new SSB block or burst (e.g., as described with reference to FIG. 3). The UE 115-a may have already determined available uplink slots 220 for uplink repetition during the first counting procedure according to the first control signal 205. In some examples, the UE 115-a may drop all remaining repetitions. In some examples, the UE 115-a may drop the uplink repetitions associated with an invalid slot 220 (e.g., that become an invalid slot 220 based on the added SSB). In such examples, the UE 115-a may transmit a decreased quantity of repetitions due to the dropped repetition (e.g., if 8 repetitions were initially scheduled and one slot 220 becomes unavailable due to a conflicting SSB, then the UE 115-a may transmit 7 repetitions instead). Additionally, or alternatively, the UE 115-a replace the dropped repetitions with one or more repetition in future available slots 220. In such examples, the UE 115-a may transmit the same quantity of repetitions due to the added repetition in a subsequent slot 220 (e.g., if 8 repetitions were initially scheduled and one slot 220 becomes unavailable due to a conflicting SSB, then the UE 115-a may drop a repetition in the conflicted slot 220 and add another repetition in a subsequent available slot according to a second counting procedure, resulting in a total of 8 repetitions). The newly added repetition may be a new repetition, the same repetition quantity as the dropped repetition, or a copy of a last repetition or first repetition.

In some cases, the second control signal 210 may remove an SSB block or burst. The UE 115-a may not make any changes (e.g., may refrain from transmitting via the newly available slot according to the first counting procedure). In some examples, the UE 115-a may transmit the uplink repetitions earlier in time by using the previously unavailable (e.g., newly valid) slot 220 (e.g., if the UE 115-a is scheduled with 16 repetitions and a slot becomes available due to the second control signal 210, then the UE 115-a may transmit the 16 repetitions by transmitting one of the 16 repetitions in the newly available slot, resulting in a faster completion of all 16 repetitions). In some examples, the UE 115-a may transmit more uplink repetitions in the previously unavailable (e.g., newly available) slots 220 (e.g., if the UE 115-a is scheduled with 16 repetitions and a slot becomes available due to the second control signal 210, then the UE 115-a may transmit 17 repetitions by adding an additional repetition to be transmitted via the newly available slot 220). An additionally transmitted repetition may be another (e.g., different) repetition, or a copy of another transmitted repetition.

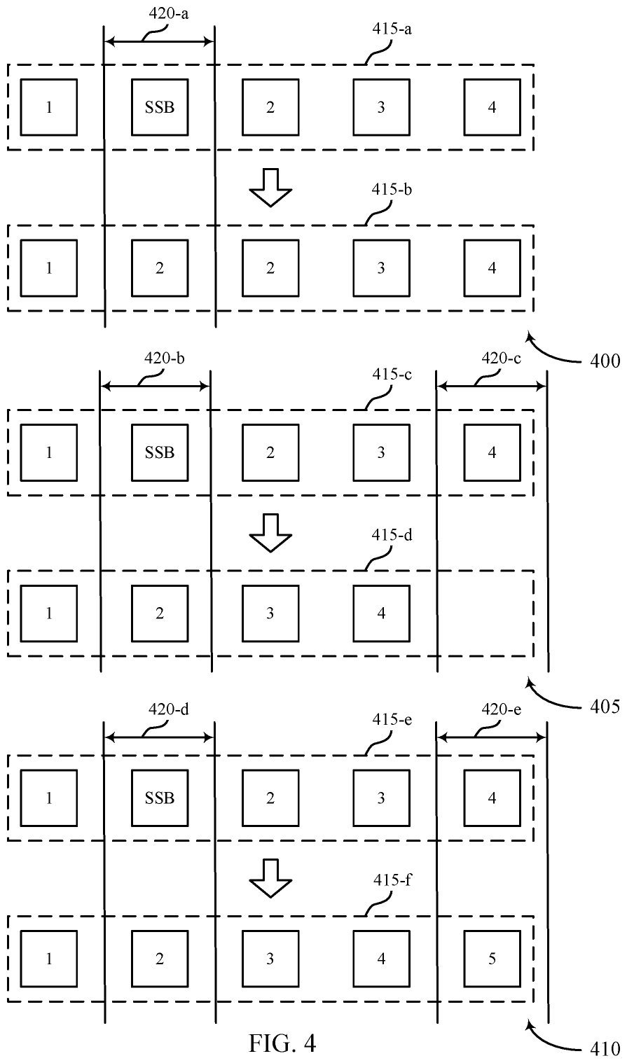

In some cases, the second control signal 210 may remove an SSB block or burst (e.g., as described with reference to FIG. 4). In some examples, the UE 115-a may not utilize the slot 220 associated with the removed SSB block or burst. In some examples, the UE 115-a may transmit a repeated uplink repetition (e.g., an uplink associated with the same index or repetition number) via the previously unavailable (e.g., newly available) slot 220. In some cases, the UE 115-a may transmit more uplink repetitions in the previously unavailable (e.g., newly available) slots 220. In some cases, the UE 115-a may transmit the uplink repetitions earlier in time by using the previously unavailable (e.g., newly valid) slot 220.

The UE 115-a may receive a second control signal 210 before the UE 115-a determines the quantity of available slots 220 for uplink repetition (e.g., prior to performing the first uplink repetition counting procedure). In some examples, the UE 115-a may follow a set of rules associated with slot 220 validity determination under the new dynamic SSB adaptation. In some examples, the UE 115-a may follow a set of rules associated with slot 220 validity determination without considering the new dynamic SSB adaptation (e.g., the UE 115-a may follow the legacy UE behavior which may not be aware of the dynamic SSB adaptation). The UE 115-a may follow the rules associated slot 220 validity determination without considering the new dynamic SSB adaptation based on the dynamic adaptation being less than a threshold length (e.g., a single block). In some cases, the network entity 105-a may select where to transmit the new SSB block.

FIG. 3 shows an example of a timeline 300 and a timeline 305 that supports slot counting and uplink repetition considerations under dynamic SSB adaptation in accordance with one or more aspects of the present disclosure. In some examples, the timeline 300 and the timeline 305 may implement, or be implemented by, aspects of wireless communication system 100 or wireless communications systems 200. For example, a UE 115, which may be an example of corresponding devices described with reference to FIGS. 1 and 2, may determine the timeline 300 or the timeline 305 for transmitting uplink repetitions according to first control signaling (e.g., RRC signaling) and second control signaling (e.g., dynamic adaptation of an SSB configuration).

In some cases, the UE 115 may receive a control signal (e.g., a second control signal indicating dynamic adaptation of the SSB configuration as described with reference to FIG. 2) or an indication of a dynamic adaptation of SSB in the time domain after the UE 115-a has already determined the available uplink slots 315 for uplink repetition (e.g., performed the first uplink repetition counting procedure as described with reference to FIG. 2). The dynamic adaptation may add one or more SSB blocks, bursts, or transmissions. In some cases, the one or more SSB blocks, bursts, or transmissions may overlap with one or more selected slots 315 in a set of available slots 315 for uplink repetitions. In some examples, the UE 115 may drop all uplink repetitions based on the dynamic adaptation.

In some examples, in accordance with timeline 300, the UE 115-a may drop any uplink repetitions associated with one or more invalid slots 315 (e.g., a slot 315 that became an invalid slot 315 based on the added SSB). For example, the UE 115-a may utilize a smaller quantity of actual repetitions (e.g., less actual uplink repetitions occur).

In some cases, the UE 115 may perform a first uplink repetition counting procedure 310-a. The UE 115 may determine a set of available slots 315 for uplink repetition based on the first uplink repetition counting procedure. The UE 115 may receive a control signal indicating that an SSB transmission may be scheduled for a slot 315-a. The UE 115 may perform a second uplink repetition counting procedure 310-b based on the dynamic adaptation. The UE 115 may drop the uplink repetition scheduled for the previously available slot 315-a (e.g., the uplink repetition two) based on the SSB transmission being schedule for slot 315-a (e.g., the UE 115 may refrain from transmitting an uplink repetition via the slot 315-a). In some examples (e.g., according to the timeline 300), the UE 115 may transmit less repetitions based on having dropped one repetition. For instance, if the UE 115 is scheduled to transmit 4 repetitions (e.g., as counted in the first uplink repetition counting procedure 310-a), the UE 115 may transmit 3 uplink repetitions (e.g., the uplink repetitions 1, 3, and 4).

In some examples, in accordance with timeline 305, the UE 115-a may drop the repetitions associated with one or more invalid slots 315. Additionally, or alternatively, the UE 115 may replace the repetitions with one or more repetitions in future available slots 315. For example, the UE 115 may utilize the same quantity of repetitions (e.g., the same quantity of uplink repetitions occur) based on counting an additional available slot 315-c.

In some cases, the UE 115 may perform a first uplink repetition counting procedure 310-c. The UE 115 may determine a set of available slots 315 for uplink repetition based on the first uplink repetition counting procedure. The UE 115 may receive a dynamic adaptation indicating that an SSB transmission may be scheduled for a slot 315-b. The UE 115 may perform a second uplink repetition counting procedure 310-d based on the dynamic adaptation. The UE 115 may reschedule one or more uplink repetitions such that the quantity of uplink repetitions remains the same. For example, the UE 115 may determine an additional available slot 315-c for uplink repetition based on the second uplink repetition counting procedure 310-d. The UE 115 may reschedule or shift the uplink repetitions based on the additional available slot 315-c. The UE 115 may add a new repetition to the counted uplink repetitions, or may shift repetitions in time, to accommodate for the newly dropped repetition (e.g., repetition 2 in slot 315-b) and the newly added repetition (e.g., repetition 4 in slot 315-c).

FIG. 4 shows an example of a timeline 400, a timeline 405, and a timeline 410 that supports slot counting and uplink repetition considerations under dynamic SSB adaptation in accordance with one or more aspects of the present disclosure. In some examples, the timeline 400, the timeline 405, and the timeline 410 may implement, or be implemented by, aspects of wireless communication system 100, wireless communications system 200, the timeline 300, or the timeline 305. For example, a UE 115, which may be an example of corresponding devices described with reference to FIGS. 1-3, may perform wireless communications according to the timeline 400, the timeline 405, or the timeline 410.

In some cases, the UE 115 may receive a control signaling indicating a dynamic adaptation of SSBs (e.g., a second control signal as described with reference to FIG. 2) or an indication of a dynamic adaptation of SSB in the time domain after the UE 115-a has already determined the available uplink slots 420 for uplink repetitions (e.g., performed the first uplink repetition counting procedure as described with reference to FIG. 2). The dynamic adaptation may remove an SSB block, burst, or transmission. In some examples, the UE 115-a may not utilize the slot 420 associated with the removed SSB block, burst, or transmission (e.g., the UE 115-a may make no change in available slot counting and available slot determination as determined by the uplink repetition counting procedure 415-a).

In some examples, in accordance with timeline 400, the UE 115-a may transmit a repeated uplink repetition (e.g., an uplink associated with the same index or repetition number) via the previously unavailable (e.g., newly available) slot.

For example, the UE 115 may perform a first uplink repetition counting procedure 415-a. The UE 115 may determine a set of available slots 420 (e.g., candidate slots 420) for uplink repetition based on the first uplink repetition counting procedure. The UE 115 may receive a control message indicating that a slot 420-a may no longer be scheduled for an SSB transmission. The UE 115 may perform a second uplink repetition counting procedure 415-b based on the dynamic adaptation. The UE 115 may determine an available slot 420-a for uplink repetition based on the second uplink repetition counting procedure 415-b. For example, the UE 115 may add the slot 420-a to the set of available slots 420. In some cases, the UE 115 may double count the repetition associated with the following available slot. For example, the UE 115 may repeat the following uplink repetition (e.g., uplink repetition 2) in the second uplink repetition counting procedure (e.g., the UE 115 may transmit the uplink repetition 2 of the uplink message via both the slot in which the uplink repetition was previously counted, and the slot 420-a).

In some examples, in accordance with timeline 405, the UE 115 may transmit the uplink repetitions earlier in time by using the previously unavailable (e.g., newly valid) slot. The reduced transmission time may provide less latency while transmitting the same quantity of uplink repetitions as determined via the first uplink repetition counting procedure.

For example, the UE 115 may perform a first uplink repetition counting procedure 415-c. The UE 115 may determine a set of available slots 420 for uplink repetition based on the first uplink repetition counting procedure. The UE 115 may receive a control signal indicating that a slot 420-b may no longer be scheduled for an SSB transmission. The UE 115 may perform a second uplink repetition counting procedure 415-d based on the dynamic adaptation. The UE 115 may determine an available slot 420-b for uplink repetition based on the second uplink repetition counting procedure 415-d. For example, the UE 115 may add the slot 420-b to the set of available slots 420. The UE 115 may adjust the uplink repetitions to transmit the uplink repetitions earlier in time by using the newly available slot 420-b. For example, the UE 115 may shift the subsequent uplink repetitions in time to utilize the available slot 420-b (e.g., the UE 115 may transmit each repetition earlier in time such that repetition 2 is transmitted via the slot 420-b, repetitions 3 and 4 are transmitted earlier in time than previously determined in the uplink repetition counting procedure 415-c, and all repetitions are transmitted prior to the slot 420-c.

In some examples, in accordance with timeline 410, the UE 115-a may transmit more uplink repetitions in the previously unavailable (e.g., newly available) slots. The UE 115 may utilize additional uplink repetitions for the uplink message.

In some cases, the UE 115 may perform a first uplink repetition counting procedure 415-e. The UE 115 may determine a set of available slots 420 for uplink repetition based on the first uplink repetition counting procedure. The UE 115 may receive a control signal indicating that a slot 420-d may no longer be scheduled for an SSB transmission. The UE 115 may perform a second uplink repetition counting procedure 415-f based on the dynamic adaptation indicated by the control signal. The UE 115 may determine an available slot 420-d for uplink repetition based on the second uplink repetition counting procedure 415-b. For example, the UE 115 may add the slot 420-d to the set of available slots 420. The UE 115 reschedule the uplink repetitions to transmit the uplink repetitions early. For example, the UE 115 may shift the following uplink repetitions to utilize the available slot 420-b (e.g., similar to the timeline 405). Additionally, or alternatively, the UE 115 may transmit an additional uplink repetition (e.g., the uplink repetition 5) in the slot 420-e (e.g., previously counted for the repetition 4 according to the uplink repetition counting procedure 415-e) of the set of available slots 420 for uplink repetition.

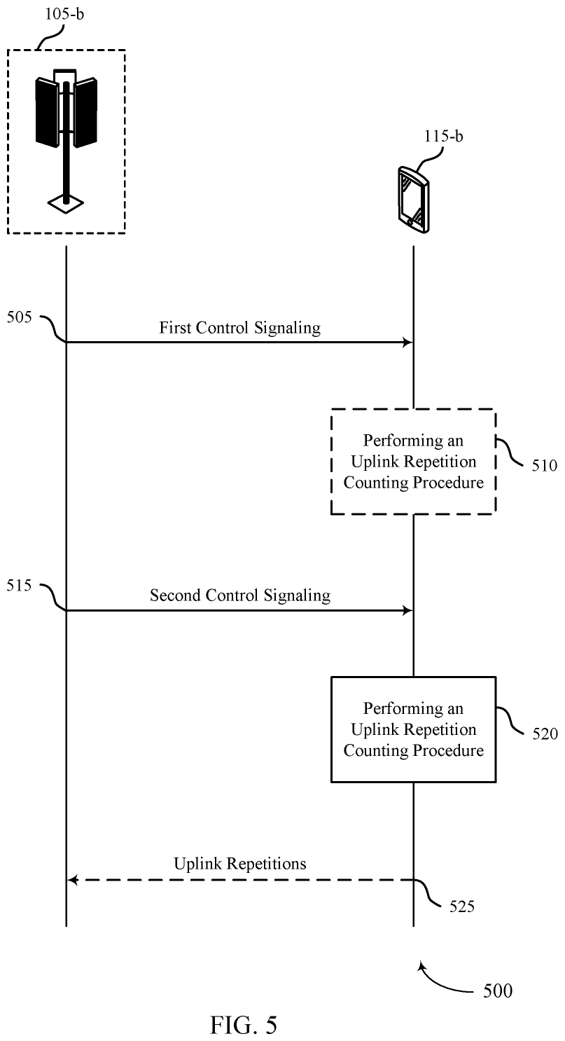

FIG. 5 shows an example of a process flow 500 that supports slot counting and uplink repetition considerations under dynamic SSB adaptation in accordance with one or more aspects of the present disclosure. In some examples, process flow 500 may implement aspects of, or be implemented by aspects of, the wireless communication system 100, the wireless communication system 200, the timeline 300, the timeline 305, the timeline 400, the timeline 405, or the timeline 410. For example, the process flow 500 may include a UE 115-b and a network entity 105-b which may be examples of corresponding devices described herein with reference to FIGS. 1 and 4.

At 505, the UE 115-b may receive first control signaling indicating a first set of slots allocated for one or more SSBs. A first set of candidate uplink slots (e.g., available slots) for uplink repetition may be based on the first set of slots.

In some cases, at 510, the UE 115-b may perform an uplink repetition counting procedure on the first set of candidate uplink slots for uplink repetition before receiving a second control signaling. The uplink repetition counting procedure on the first set of candidate uplink slots based on the first control signaling may be an example of the first uplink repetition counting procedure described with reference to FIGS. 1-4. However, in some examples (e.g., as described with reference to FIG. 5), the uplink repetition counting procedure on the first set of candidate uplink slots based on the first control signaling may be referred to as a second uplink repetition counting procedure (e.g., with reference to another uplink repetition counting procedure performed with reference to the second control signaling received at 520).

At 515, the UE 115-b may receive the second control signaling that indicates an update to the first set of slots allocated for the one or more SSBs resulting in a second set of slots allocated for the one or more SSBs. The second set of candidate uplink slots for uplink repetition may be based on the second set of slots. At 520, the UE 115-b may perform the uplink repetition counting procedure based on the second set of candidate uplink slots for uplink repetition. The uplink repetition counting procedure performed at 520 may be an example of the second uplink repetition counting procedure described with reference to FIGS. 1-4. In some examples, the uplink repetition counting procedure performed at 520 may be referred to as an uplink repetition counting procedure, or a first uplink repetition counting procedure (e.g., where the previous uplink repetition counting procedure performed at 510 may be referred to as the second uplink repetition counting procedure.

In some cases, the UE 115-b may receive, via the second control signaling, an indication of at least a slot allocated for SSB that overlaps with a first candidate uplink slot of the first set of candidate uplink slots (e.g., as described with reference to FIG. 3). In some examples, the UE 115-b may drop the first candidate uplink slot from the second set of candidate uplink slots. In some examples, the UE 115-b may count a new slot that does not overlap with the first candidate uplink slot towards a total quantity of uplink repetition slots associated with the second plurality of candidate uplink slots. The second set of candidate uplink slots may include the new slot. In some examples, the UE 115-a may refrain from counting the first candidate uplink slot towards a total quantity of uplink repetition slots associated with the second set of candidate uplink slots. The total quantity of uplink repetition slots associated with the second set of candidate uplink slots may be less than a total quantity of uplink repetition slots associated with the first plurality of candidate uplink slots.

In some cases, the UE 115-b may receive, via the second control signaling, an indication that at least a slot of the first set of slots allocated for the one or more SSBs is not included in the second set of slots allocated for the one or more SSBs, such that the slot is not allocated for the one or more SSBs (e.g., as described with reference to FIG. 4). In some examples, the UE 115-b may count the slot towards a total quantity of uplink repetition slots associated with the second set of candidate uplink slots. The second plurality of candidate uplink slots may include the slot. In some examples, the UE 115-b may refrain from counting a last candidate uplink slot of the first plurality of candidate uplink slots towards the total quantity of uplink repetition slots associated with the second set of candidate uplink slots based on counting the slot. In some examples, the UE 115-b may allocate the slot for a repetition of a previous slot of the second set of candidate uplink slots.

In some cases, the UE 115-b may receive, via the second control signaling, an indication of the uplink repetition counting procedure. The uplink repetition counting procedure may indicate for the UE 115-b to skip uplink repetitions on a removed uplink slots. In some cases, the UE 115-b may receive, via the second control signaling, an indication of the uplink repetition counting procedure. The uplink repetition counting procedure may indicate for the UE 115-b to reschedule uplink repetitions on a removed uplink slots.

At 525, the UE 115-b may transmit one or more uplink repetitions via the second set of candidate uplink slots according to the uplink repetition counting procedure performed at 520.

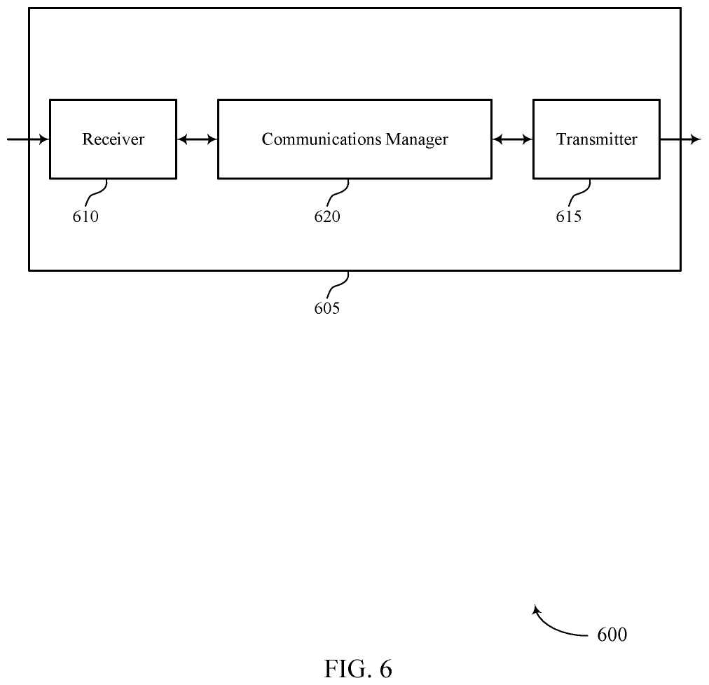

FIG. 6 shows a block diagram 600 of a device 605 that supports slot counting and uplink repetition considerations under dynamic SSB adaptation in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to slot counting and uplink repetition considerations under dynamic SSB adaptation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to slot counting and uplink repetition considerations under dynamic SSB adaptation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of slot counting and uplink repetition considerations under dynamic SSB adaptation as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving first control signaling indicating a first set of slots allocated for one or more SSBs, where a first set of multiple candidate uplink slots for uplink repetition are based on the first set of slots. The communications manager 620 is capable of, configured to, or operable to support a means for receiving second control signaling that indicates an update to the first set of slots allocated for the one or more SSBs resulting in a second set of slots allocated for the one or more SSBs, where a second set of multiple candidate uplink slots for uplink repetition are based on the second set of slots. The communications manager 620 is capable of, configured to, or operable to support a means for performing an uplink repetition counting procedure based on the second set of multiple candidate uplink slots for uplink repetition.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources and the like.

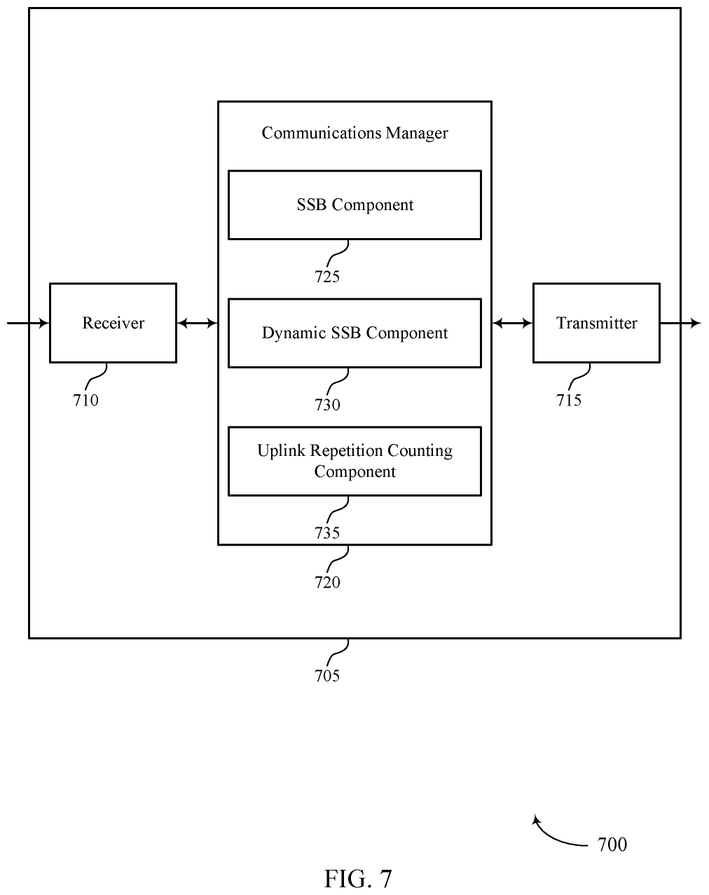

FIG. 7 shows a block diagram 700 of a device 705 that supports slot counting and uplink repetition considerations under dynamic SSB adaptation in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to slot counting and uplink repetition considerations under dynamic SSB adaptation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to slot counting and uplink repetition considerations under dynamic SSB adaptation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of slot counting and uplink repetition considerations under dynamic SSB adaptation as described herein. For example, the communications manager 720 may include an SSB component 725, a dynamic SSB component 730, an uplink repetition counting component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The SSB component 725 is capable of, configured to, or operable to support a means for receiving first control signaling indicating a first set of slots allocated for one or more SSBs, where a first set of multiple candidate uplink slots for uplink repetition are based on the first set of slots. The dynamic SSB component 730 is capable of, configured to, or operable to support a means for receiving second control signaling that indicates an update to the first set of slots allocated for the one or more SSBs resulting in a second set of slots allocated for the one or more SSBs, where a second set of multiple candidate uplink slots for uplink repetition are based on the second set of slots. The uplink repetition counting component 735 is capable of, configured to, or operable to support a means for performing an uplink repetition counting procedure based on the second set of multiple candidate uplink slots for uplink repetition.

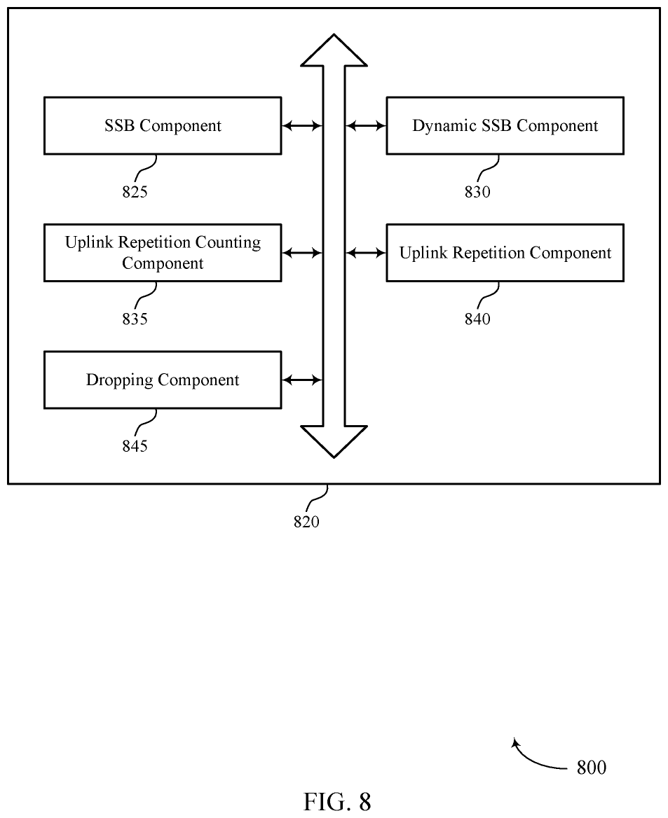

FIG. 8 shows a block diagram 800 of a communications manager 820 that supports slot counting and uplink repetition considerations under dynamic SSB adaptation in accordance with one or more aspects of the present disclosure. The communications manager 820 may be an example of aspects of a communications manager 620, a communications manager 720, or both, as described herein. The communications manager 820, or various components thereof, may be an example of means for performing various aspects of slot counting and uplink repetition considerations under dynamic SSB adaptation as described herein. For example, the communications manager 820 may include an SSB component 825, a dynamic SSB component 830, an uplink repetition counting component 835, an uplink repetition component 840, a dropping component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The SSB component 825 is capable of, configured to, or operable to support a means for receiving first control signaling indicating a first set of slots allocated for one or more SSBs, where a first set of multiple candidate uplink slots for uplink repetition are based on the first set of slots. The dynamic SSB component 830 is capable of, configured to, or operable to support a means for receiving second control signaling that indicates an update to the first set of slots allocated for the one or more SSBs resulting in a second set of slots allocated for the one or more SSBs, where a second set of multiple candidate uplink slots for uplink repetition are based on the second set of slots. The uplink repetition counting component 835 is capable of, configured to, or operable to support a means for performing an uplink repetition counting procedure based on the second set of multiple candidate uplink slots for uplink repetition.

In some examples, the uplink repetition counting component 835 is capable of, configured to, or operable to support a means for performing a second uplink repetition counting procedure based on the first set of multiple candidate uplink slots for uplink repetition before receiving the second control signaling, where performing the uplink repetition counting procedure includes updating the uplink repetition counting procedure according to the second set of multiple candidate uplink slots for uplink repetition.

In some examples, the dynamic SSB component 830 is capable of, configured to, or operable to support a means for receiving, via the second control signaling, an indication of at least a slot allocated for SSB that overlaps with a first candidate uplink slot of the first set of multiple candidate uplink slots.

In some examples, the dropping component 845 is capable of, configured to, or operable to support a means for dropping the first candidate uplink slot from the second set of multiple candidate uplink slots.

In some examples, to support uplink repetition counting procedure, the uplink repetition counting component 835 is capable of, configured to, or operable to support a means for counting a new slot that does not overlap with the first candidate uplink slot towards a total quantity of uplink repetition slots associated with the second set of multiple candidate uplink slots, where the second set of multiple candidate uplink slots includes the new slot.

In some examples, to support uplink repetition counting procedure, the uplink repetition counting component 835 is capable of, configured to, or operable to support a means for refraining from counting the first candidate uplink slot towards a total quantity of uplink repetition slots associated with the second set of multiple candidate uplink slots.

In some examples, the total quantity of uplink repetition slots associated with the second set of multiple candidate uplink slots is less than a total quantity of uplink repetition slots associated with the first set of multiple candidate uplink slots.

In some examples, the dynamic SSB component 830 is capable of, configured to, or operable to support a means for receiving, via the second control signaling, an indication that at least a slot of the first set of slots allocated for the one or more SSBs is not included in the second set of slots allocated for the one or more SSBs, such that the slot is not allocated for the one or more SSBs.

In some examples, to support uplink repetition counting procedure, the uplink repetition counting component 835 is capable of, configured to, or operable to support a means for counting the slot towards a total quantity of uplink repetition slots associated with the second set of multiple candidate uplink slots, where the second set of multiple candidate uplink slots includes the slot.

In some examples, to support uplink repetition counting procedure, the uplink repetition counting component 835 is capable of, configured to, or operable to support a means for refraining from counting a last candidate uplink slot of the first set of multiple candidate uplink slots towards the total quantity of uplink repetition slots associated with the second set of multiple candidate uplink slots based at least in part on counting the slot.

In some examples, to support uplink repetition counting procedure, the uplink repetition counting component 835 is capable of, configured to, or operable to support a means for allocating the slot for a repetition of a previous slot of the second set of multiple candidate uplink slots.

In some examples, the uplink repetition counting component 835 is capable of, configured to, or operable to support a means for receiving, via the second control signaling, an indication of the uplink repetition counting procedure, where the uplink repetition counting procedure indicates for the UE to skip uplink repetitions on a removed uplink slots.

In some examples, the uplink repetition counting component 835 is capable of, configured to, or operable to support a means for receiving, via the second control signaling, an indication of the uplink repetition counting procedure, where the uplink repetition counting procedure indicates for the UE to reschedule uplink repetitions on a removed uplink slots.

In some examples, the uplink repetition component 840 is capable of, configured to, or operable to support a means for transmitting one or more uplink repetitions via the second set of multiple candidate uplink slots according to the uplink repetition counting procedure.

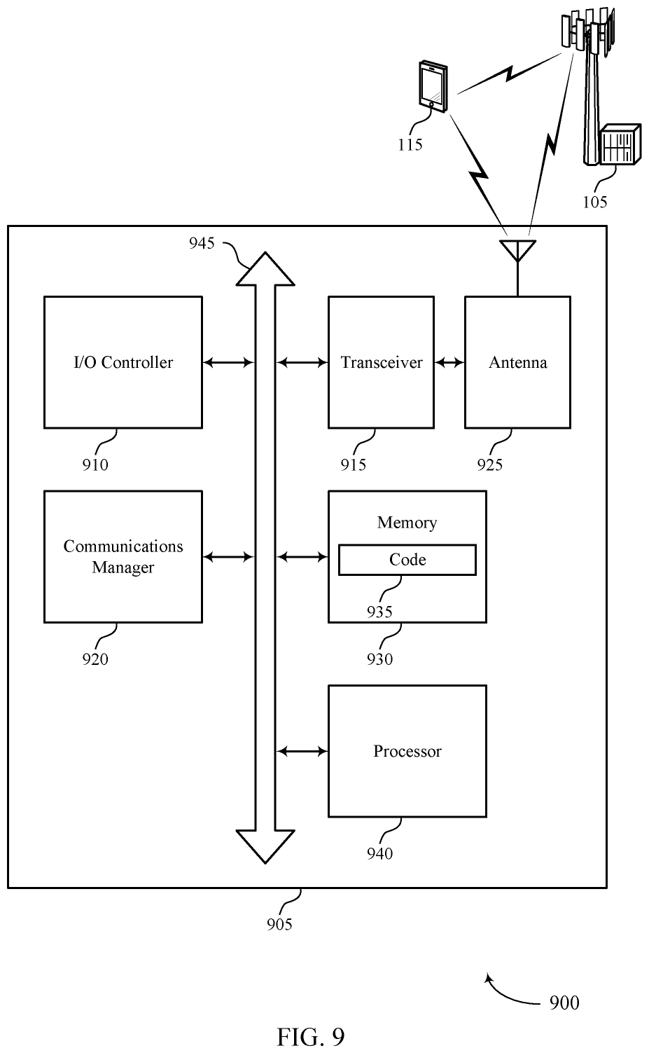

FIG. 9 shows a diagram of a system 900 including a device 905 that supports slot counting and uplink repetition considerations under dynamic SSB adaptation in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting slot counting and uplink repetition considerations under dynamic SSB adaptation). For example, the device 905 or a component of the device 905 may include at least one processor 940 and at least one memory 930 coupled with or to the at least one processor 940, the at least one processor 940 and the at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving first control signaling indicating a first set of slots allocated for one or more SSBs, where a first set of multiple candidate uplink slots for uplink repetition are based on the first set of slots. The communications manager 920 is capable of, configured to, or operable to support a means for receiving second control signaling that indicates an update to the first set of slots allocated for the one or more SSBs resulting in a second set of slots allocated for the one or more SSBs, where a second set of multiple candidate uplink slots for uplink repetition are based on the second set of slots. The communications manager 920 is capable of, configured to, or operable to support a means for performing an uplink repetition counting procedure based on the second set of multiple candidate uplink slots for uplink repetition.

By including or configuring the communications manager 920 in accordance with examples as described herein, the device 905 may support techniques for device-level advantages improved communication reliability, reduced latency, more efficient utilization of communication resources, improved coordination between devices, and the like.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of slot counting and uplink repetition considerations under dynamic SSB adaptation as described herein, or the at least one processor 940 and the at least one memory 930 may be otherwise configured to, individually or collectively, perform or support such operations.

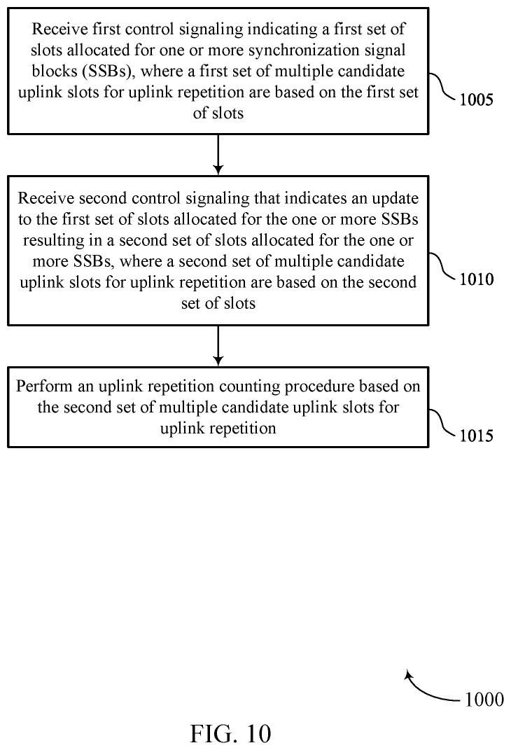

FIG. 10 shows a flowchart illustrating a method 1000 that supports slot counting and uplink repetition considerations under dynamic SSB adaptation in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving first control signaling indicating a first set of slots allocated for one or more SSBs, where a first set of multiple candidate uplink slots for uplink repetition are based on the first set of slots. The operations of 1005 may be performed in accordance with examples as disclosed herein. In some examples, aspects of the operations of 1005 may be performed by an SSB component 825 as described with reference to FIG. 8.

At 1010, the method may include receiving second control signaling that indicates an update to the first set of slots allocated for the one or more SSBs resulting in a second set of slots allocated for the one or more SSBs, where a second set of multiple candidate uplink slots for uplink repetition are based on the second set of slots. The operations of 1010 may be performed in accordance with examples as disclosed herein. In some examples, aspects of the operations of 1010 may be performed by a dynamic SSB component 830 as described with reference to FIG. 8.

At 1015, the method may include performing an uplink repetition counting procedure based on the second set of multiple candidate uplink slots for uplink repetition. The operations of 1015 may be performed in accordance with examples as disclosed herein. In some examples, aspects of the operations of 1015 may be performed by an uplink repetition counting component 835 as described with reference to FIG. 8.

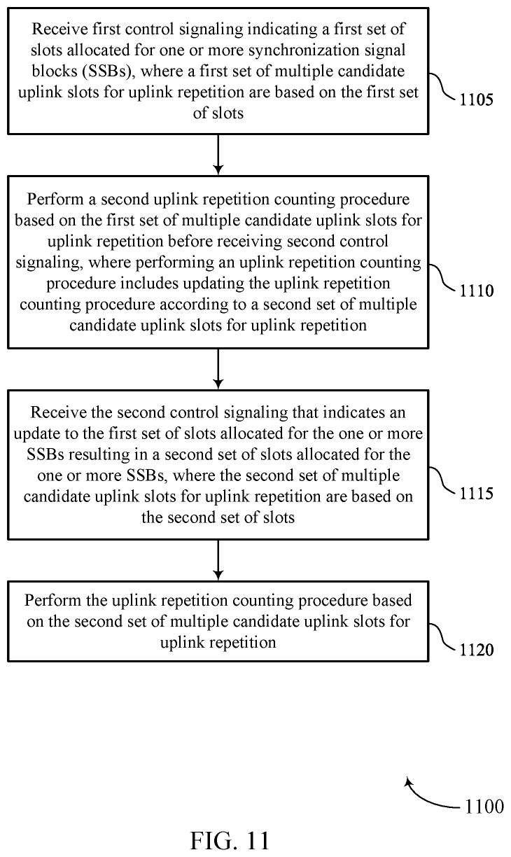

FIG. 11 shows a flowchart illustrating a method 1100 that supports slot counting and uplink repetition considerations under dynamic SSB adaptation in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving first control signaling indicating a first set of slots allocated for one or more SSBs, where a first set of multiple candidate uplink slots for uplink repetition are based on the first set of slots. The operations of 1105 may be performed in accordance with examples as disclosed herein. In some examples, aspects of the operations of 1105 may be performed by an SSB component 825 as described with reference to FIG. 8.

At 1110, the method may include performing a second uplink repetition counting procedure based on the first set of multiple candidate uplink slots for uplink repetition before receiving a second control signaling, where performing the uplink repetition counting procedure includes updating an uplink repetition counting procedure according to a second set of multiple candidate uplink slots for uplink repetition. The operations of 1110 may be performed in accordance with examples as disclosed herein. In some examples, aspects of the operations of 1110 may be performed by an uplink repetition counting component 835 as described with reference to FIG. 8.

At 1115, the method may include receiving the second control signaling that indicates an update to the first set of slots allocated for the one or more SSBs resulting in a second set of slots allocated for the one or more SSBs, where the second set of multiple candidate uplink slots for uplink repetition are based on the second set of slots. The operations of 1115 may be performed in accordance with examples as disclosed herein. In some examples, aspects of the operations of 1115 may be performed by a dynamic SSB component 830 as described with reference to FIG. 8.

At 1120, the method may include performing the uplink repetition counting procedure based on the second set of multiple candidate uplink slots for uplink repetition. The operations of 1120 may be performed in accordance with examples as disclosed herein. In some examples, aspects of the operations of 1120 may be performed by an uplink repetition counting component 835 as described with reference to FIG. 8.

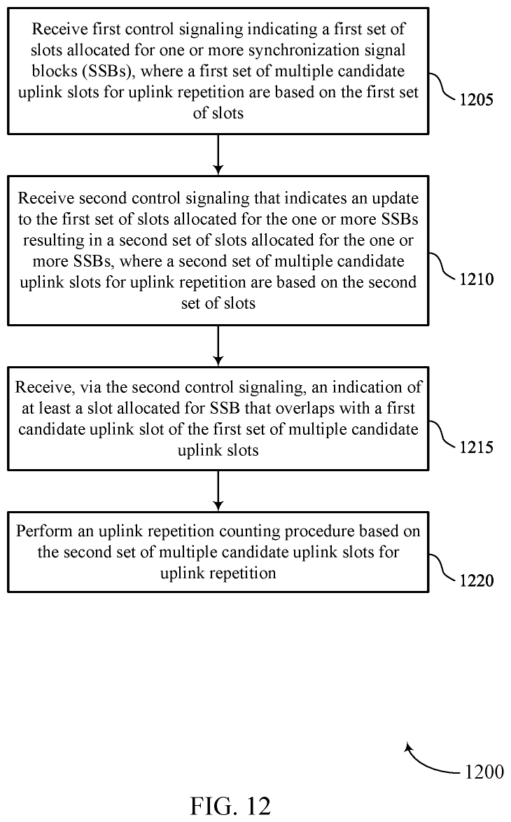

FIG. 12 shows a flowchart illustrating a method 1200 that supports slot counting and uplink repetition considerations under dynamic SSB adaptation in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving first control signaling indicating a first set of slots allocated for one or more SSBs, where a first set of multiple candidate uplink slots for uplink repetition are based on the first set of slots. The operations of 1205 may be performed in accordance with examples as disclosed herein. In some examples, aspects of the operations of 1205 may be performed by an SSB component 825 as described with reference to FIG. 8.

At 1210, the method may include receiving second control signaling that indicates an update to the first set of slots allocated for the one or more SSBs resulting in a second set of slots allocated for the one or more SSBs, where a second set of multiple candidate uplink slots for uplink repetition are based on the second set of slots. The operations of 1210 may be performed in accordance with examples as disclosed herein. In some examples, aspects of the operations of 1210 may be performed by a dynamic SSB component 830 as described with reference to FIG. 8.

At 1215, the method may include receiving, via the second control signaling, an indication of at least a slot allocated for SSB that overlaps with a first candidate uplink slot of the first set of multiple candidate uplink slots. The operations of 1215 may be performed in accordance with examples as disclosed herein. In some examples, aspects of the operations of 1215 may be performed by a dynamic SSB component 830 as described with reference to FIG. 8.

At 1220, the method may include performing an uplink repetition counting procedure based on the second set of multiple candidate uplink slots for uplink repetition. The operations of 1220 may be performed in accordance with examples as disclosed herein. In some examples, aspects of the operations of 1220 may be performed by an uplink repetition counting component 835 as described with reference to FIG. 8.

The following provides an overview of aspects of the present disclosure:

Aspect 1: A method for wireless communications at a UE, comprising: receiving first control signaling indicating a first set of slots allocated for one or more SSBs, wherein a first plurality of candidate uplink slots for uplink repetition are based at least in part on the first set of slots; receiving second control signaling that indicates an update to the first set of slots allocated for the one or more SSBs resulting in a second set of slots allocated for the one or more SSBs, wherein a second plurality of candidate uplink slots for uplink repetition are based at least in part on the second set of slots; and performing an uplink repetition counting procedure based at least in part on the second plurality of candidate uplink slots for uplink repetition.

Aspect 2: The method of aspect 1, further comprising: performing a second uplink repetition counting procedure based at least in part on the first plurality of candidate uplink slots for uplink repetition before receiving the second control signaling, wherein performing the uplink repetition counting procedure comprises updating the uplink repetition counting procedure according to the second plurality of candidate uplink slots for uplink repetition.

Aspect 3: The method of any of aspects 1 through 2, further comprising: receiving, via the second control signaling, an indication of at least a slot allocated for SSB that overlaps with a first candidate uplink slot of the first plurality of candidate uplink slots.

Aspect 4: The method of aspect 3, further comprising: dropping the first candidate uplink slot from the second plurality of candidate uplink slots.

Aspect 5: The method of aspect 4, wherein the uplink repetition counting procedure further comprises: counting a new slot that does not overlap with the first candidate uplink slot towards a total quantity of uplink repetition slots associated with the second plurality of candidate uplink slots, wherein the second plurality of candidate uplink slots comprises the new slot.

Aspect 6: The method of any of aspects 4, wherein the uplink repetition counting procedure further comprises: refraining from counting the first candidate uplink slot towards a total quantity of uplink repetition slots associated with the second plurality of candidate uplink slots.

Aspect 7: The method of aspect 6, wherein the total quantity of uplink repetition slots associated with the second plurality of candidate uplink slots is less than a total quantity of uplink repetition slots associated with the first plurality of candidate uplink slots.

Aspect 8: The method of any of aspects 1 through 7, further comprising: receiving, via the second control signaling, an indication that at least a slot of the first set of slots allocated for the one or more SSBs is not included in the second set of slots allocated for the one or more SSBs, such that the slot is not allocated for the one or more SSBs.

Aspect 9: The method of aspect 8, wherein the uplink repetition counting procedure further comprises: counting the slot towards a total quantity of uplink repetition slots associated with the second plurality of candidate uplink slots, wherein the second plurality of candidate uplink slots comprises the slot.

Aspect 10: The method of aspect 9, wherein the uplink repetition counting procedure further comprises: refraining from counting a last candidate uplink slot of the first plurality of candidate uplink slots towards the total quantity of uplink repetition slots associated with the second plurality of candidate uplink slots based at least in part on counting the slot.

Aspect 11: The method of any of aspects 8, wherein the uplink repetition counting procedure further comprises: allocating the slot for a repetition of a previous slot of the second plurality of candidate uplink slots.

Aspect 12: The method of any of aspects 1 through 11, further comprising: receiving, via the second control signaling, an indication of the uplink repetition counting procedure, wherein the uplink repetition counting procedure indicates for the UE to skip uplink repetitions on a removed uplink slots.

Aspect 13: The method of any of aspects 1 through 11, further comprising: receiving, via the second control signaling, an indication of the uplink repetition counting procedure, wherein the uplink repetition counting procedure indicates for the UE to reschedule uplink repetitions on a removed uplink slots.

Aspect 14: The method of any of aspects 1 through 13, further comprising: transmitting one or more uplink repetitions via the second plurality of candidate uplink slots according to the uplink repetition counting procedure.

Aspect 15: A UE for wireless communications, comprising one or more memories storing processor-executable code, and one or more processors coupled with the one or more memories and individually or collectively operable to execute the code to cause the UE to perform a method of any of aspects 1 through 14.

Aspect 16: A UE for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling indicating a first set of slots allocated for one or more synchronization signal blocks (SSBs), wherein a first plurality of candidate uplink slots for uplink repetition are based at least in part on the first set of slots;
receive second control signaling that indicates an update to the first set of slots allocated for the one or more SSBs resulting in a second set of slots allocated for the one or more SSBs, wherein a second plurality of candidate uplink slots for uplink repetition are based at least in part on the second set of slots; and
perform an uplink repetition counting procedure based at least in part on the second plurality of candidate uplink slots for uplink repetition.

2. The UE of claim 1, wherein the one or more processors are individually or collectively further operable to execute the code to cause the UE to:
perform a second uplink repetition counting procedure based at least in part on the first plurality of candidate uplink slots for uplink repetition before receiving the second control signaling, wherein performing the uplink repetition counting procedure comprises updating the uplink repetition counting procedure according to the second plurality of candidate uplink slots for uplink repetition.

3. The UE of claim 1, wherein the one or more processors are individually or collectively further operable to execute the code to cause the UE to:
receive, via the second control signaling, an indication of at least a slot allocated for SSB that overlaps with a first candidate uplink slot of the first plurality of candidate uplink slots.

4. The UE of claim 3, wherein the one or more processors are individually or collectively further operable to execute the code to cause the UE to:
drop the first candidate uplink slot from the second plurality of candidate uplink slots.

5. The UE of claim 4, wherein, to perform the uplink repetition counting procedure, the one or more processors are individually or collectively further operable to execute the code to cause the UE to:
count a new slot that does not overlap with the first candidate uplink slot towards a total quantity of uplink repetition slots associated with the second plurality of candidate uplink slots, wherein the second plurality of candidate uplink slots comprises the new slot.

6. The UE of claim 4, wherein, to perform the uplink repetition counting procedure, the one or more processors are individually or collectively further operable to execute the code to cause the UE to:
refrain from counting the first candidate uplink slot towards a total quantity of uplink repetition slots associated with the second plurality of candidate uplink slots.

7. The UE of claim 6, wherein the total quantity of uplink repetition slots associated with the second plurality of candidate uplink slots is less than the total quantity of uplink repetition slots associated with the first plurality of candidate uplink slots.

8. The UE of claim 1, wherein the one or more processors are individually or collectively further operable to execute the code to cause the UE to:
receive, via the second control signaling, an indication that at least a slot of the first set of slots allocated for the one or more SSBs is not included in the second set of slots allocated for the one or more SSBs, such that the slot is not allocated for the one or more SSBs.

9. The UE of claim 8, wherein, to perform the uplink repetition counting procedure, the one or more processors are individually or collectively further operable to execute the code to cause the UE to:
count the slot towards a total quantity of uplink repetition slots associated with the second plurality of candidate uplink slots, wherein the second plurality of candidate uplink slots comprises the slot.

10. The UE of claim 9, wherein, to perform the uplink repetition counting procedure, the one or more processors are individually or collectively further operable to execute the code to cause the UE to:
refrain from counting a last candidate uplink slot of the first plurality of candidate uplink slots towards the total quantity of uplink repetition slots associated with the second plurality of candidate uplink slots based at least in part on counting the slot.

11. The UE of claim 8, wherein, to perform the uplink repetition counting procedure, the one or more processors are individually or collectively further operable to execute the code to cause the UE to:
allocate the slot for a repetition of a previous slot of the second plurality of candidate uplink slots.

12. The UE of claim 1, wherein the one or more processors are individually or collectively further operable to execute the code to cause the UE to:
receive, via the second control signaling, an indication of the uplink repetition counting procedure, wherein the uplink repetition counting procedure indicates for the UE to skip uplink repetitions on a removed uplink slots.

13. The UE of claim 1, wherein the one or more processors are individually or collectively further operable to execute the code to cause the UE to:
receive, via the second control signaling, an indication of the uplink repetition counting procedure, wherein the uplink repetition counting procedure indicates for the UE to reschedule uplink repetitions on a removed uplink slots.

14. The UE of claim 1, wherein the one or more processors are individually or collectively further operable to execute the code to cause the UE to:
transmit one or more uplink repetitions via the second plurality of candidate uplink slots according to the uplink repetition counting procedure.

15. A method for wireless communications at a user equipment (UE), comprising:
receiving first control signaling indicating a first set of slots allocated for one or more synchronization signal blocks (SSBs), wherein a first plurality of candidate uplink slots for uplink repetition are based at least in part on the first set of slots;
receiving second control signaling that indicates an update to the first set of slots allocated for the one or more SSBs resulting in a second set of slots allocated for the one or more SSBs, wherein a second plurality of candidate uplink slots for uplink repetition are based at least in part on the second set of slots; and
performing an uplink repetition counting procedure based at least in part on the second plurality of candidate uplink slots for uplink repetition.

16. The method of claim 15, further comprising:
performing a second uplink repetition counting procedure based at least in part on the first plurality of candidate uplink slots for uplink repetition before receiving the second control signaling, wherein performing the uplink repetition counting procedure comprises updating the uplink repetition counting procedure according to the second plurality of candidate uplink slots for uplink repetition.

17. The method of claim 15, further comprising:
receiving, via the second control signaling, an indication of at least a slot allocated for SSB that overlaps with a first candidate uplink slot of the first plurality of candidate uplink slots.

18. The method of claim 15, further comprising:
receiving, via the second control signaling, an indication that at least a slot of the first set of slots allocated for the one or more SSBs is not included in the second set of slots allocated for the one or more SSBs, such that the slot is not allocated for the one or more SSBs.

19. The method of claim 15, further comprising:
receiving, via the second control signaling, an indication of the uplink repetition counting procedure, wherein the uplink repetition counting procedure indicates for the UE to skip uplink repetitions on a removed uplink slots.

20. A non-transitory computer-readable medium storing code for wireless communications, the code comprising instructions executable by one or more processors to:
receive first control signaling indicating a first set of slots allocated for one or more synchronization signal blocks (SSBs), wherein a first plurality of candidate uplink slots for uplink repetition are based at least in part on the first set of slots;
receive second control signaling that indicates an update to the first set of slots allocated for the one or more SSBs resulting in a second set of slots allocated for the one or more SSBs, wherein a second plurality of candidate uplink slots for uplink repetition are based at least in part on the second set of slots; and
perform an uplink repetition counting procedure based at least in part on the second plurality of candidate uplink slots for uplink repetition.
